(19) United States
(12) Patent Application Publication
(10) Pub. No.: US 2019/0135371 A1
(43) Pub. Date: May 9, 2019

(54) Folding mechanism, scooter using the same, folding and locking methods thereof

(71) Applicant: E-link Technology Co., Ltd., Shenzhen (CN)

(72) Inventors: Yufeng CHENG, Shenzhen (CN); Qiusheng ZHANG, Shenzhen (CN); Pingzhi LI, Shenzhen (CN)

(73) Assignee: E-link Technology Co., Ltd.

(21) Appl. No.: 16/183,432

(22) Filed: Nov. 7, 2018

(30) Foreign Application Priority Data
Nov. 8, 2017 (CN) 201711091041.6

(51) Int. Cl. B62K 21/18; B62K 3/00; B62K 15/00; F16C 11/10

(52) U.S. Cl. CPC B62K 21/18; F16C 11/10; B62K 15/00; B62K 3/002

(57) ABSTRACT

The invention relates to folding mechanism, scooter using the same, folding and locking methods thereof. The folding mechanism is used for controlling the column of the scooter to fold relative to the footboard of the scooter. The folding mechanism comprising: base, rotating shaft, folding assembly, and triggering assembly for triggering the movement of the folding assembly. The base and folding assembly form a hinge-joint by the rotating shaft, the triggering assembly is disposed in the column, particularly slidably disposed at the side of the folding assembly. Controlling the triggering assembly to slide towards the folding assembly and press against it, can make the folding assembly fold relative to the base, the operation is time-saving and effective, furthermore, the scooter doesn't have exposed part, the structure is compact, which is safe and reliable, meanwhile, it also improves the appearance thereof.

### FIELD OF THE INVENTION

The present invention generally relates to the field of scooters, and more particularly relates to a folding mechanism, a scooter using the same, folding and locking methods thereof.

### BACKGROUND OF THE INVENTION

Scooters can be classified by driving mode into electric scooters and foot scooters, which have become popular fitness equipment, and also a transportation vehicle, many of the consumers well love it. The scooter is generally provided with a structure to make itself folded, so as to make itself easy to carry and reduce the space it occupied. Through a certain structure, the size of the bicycle or scooter can be reduced by folding it up, make it convenient for carrying and storing, which would be appropriate for people to trip.

The prior art disclosed some structures to fold the scooter up. For example, Chinese utility model patent ZL201120434127.6 disclosed a folding structure of a scooter which comprising a head tube, a front tube pivoted with the head tube, a stop sleeve, an elastic element and a folding sheath; the stop sleeve is sleeved on the junction of the head tube and front tube, it can alternatively sleeve on the pivot part of the head tube and front tube, the elastic part is disposed below the front tube but above the stop sleeve. When folded, firstly make the inner tube of the front tube retract in the outer tube, then apply force downward to make the front tube folded from vertical state to horizontal state and lie on the footboard. However, the folding structure is disposed outside of the front tube, which might easily scrape the user's body or clothing when riding or folding, moreover, it requires a lot of strength for user to pull the handle when folding and locking, the operation is inflexible and complicated.

Therefore, the folding structures of prior art still need to be improved.

### SUMMARY OF THE INVENTION

It is therefore the object of the present invention to provide a folding mechanism, scooter using the same, folding and locking methods thereof, which has a compact structure and can achieve efficient operation to fold or lock.

The present invention achieves the above-identified object by providing a folding mechanism of a scooter, to control the column of the scooter to fold relative to the footboard of the scooter, it comprising: base, rotating shaft, folding assembly, and triggering assembly for triggering the movement of the folding assembly; the base and folding assembly form a hinge-joint by the rotating shaft; the triggering assembly is disposed in the column, particularly slidably disposed at the side of the folding assembly.

The present invention achieves the above-identified object by providing a scooter, comprising column and footboard, further comprising the said folding mechanism above, the folding mechanism is rotatably disposed on the footboard and further connected to the column.

The present invention achieves the above-identified object by providing a method for folding the said folding mechanism above, comprising the following steps:

the triggering assembly slides towards the folding assembly to drive the folding assembly to release the base; the folding assembly rotates towards the footboard about the rotating shaft, to complete the folding action.

The present invention achieves the above-identified object by providing a method for locking the said folding mechanism above, comprising the following steps:

sliding the triggering assembly in the direction of keeping away from the folding assembly; the folding assembly engaged with and locked the base under the action of elastic restoring force, to reset the folding mechanism and complete the locking action of it.

Based on the above technical solution, user just need to control the triggering assembly to slide towards the folding assembly and press against it, can make the folding assembly fold relative to the base, the operation is time-saving and effective. Furthermore, the scooter doesn't have exposed part, the structure is compact, which is safe and reliable. Meanwhile, it also improves the appearance thereof.

Other objects, advantages, and new features of the present invention will become apparent from the following detailed description of the invention when considered in conjunction with the accompanied drawings.

### BRIEF DESCRIPTION OF THE DRAWINGS

FIG. 1 is an exploded view of the scooter according to a preferred embodiment of the present invention.

FIG. 2 is a perspective view of the folded scooter according to a preferred embodiment of the present invention.

FIG. 3 is a cross-sectional view of the folded scooter provided by the preferred embodiment of the present invention.

FIG. 4 is an exploded view of the folding assembly of the scooter according to a preferred embodiment of the present invention.

FIG. 5 is a partial perspective view of the folding mechanism of the scooter which is in the pre-folding state according to a preferred embodiment of the present invention.

FIG. 6 is a cross-sectional view of the folding mechanism of the scooter which is in the pre-folding state according to a preferred embodiment of the present invention.

FIG. 7 is a partial perspective view of the column of the scooter in the vertical state according to a preferred embodiment of the present invention.

FIG. 8 is a cross-sectional view of the column of the scooter in the vertical state according to a preferred embodiment of the present invention.

### DETAILED DESCRIPTION

The present invention provides a scooter, a folding mechanism and methods thereof for folding and locking it, the folding mechanism. To make the structure more compact, the triggering assembly of the folding mechanism is hiding in the inner column, so that the folding mechanism wouldn't reach to the outside of the column and footboard, which is safe and reliable for user, and also improve the scooter's appearance and its market competitiveness. At the same time, during the folding operation, the folding mechanism would be triggered by making the inner column go down to a certain lower position, which is simplified for user to operate.

To make the objects, technical solutions and effects of the present invention can be understand clearly and more explicit, the present invention will be further described in detail below with reference to the accompanying drawings and embodiments. It should be understood that the specific embodiments described herein are only used to explain the present invention, and are not intended to limit the present invention.

It should be noted that when a part is referred to as being “mounted on”, “fixed on”, “disposed on” or “connected to” another part, it can be directly on or connected to the other part, or else there may be a transition piece between the two parts. It should also be noted that, terms in the embodiments of the present invention, such as left, right, upper and lower, are merely relative concepts or are referenced to the normal usage state of the product and should not be considered as a restrictive definition.

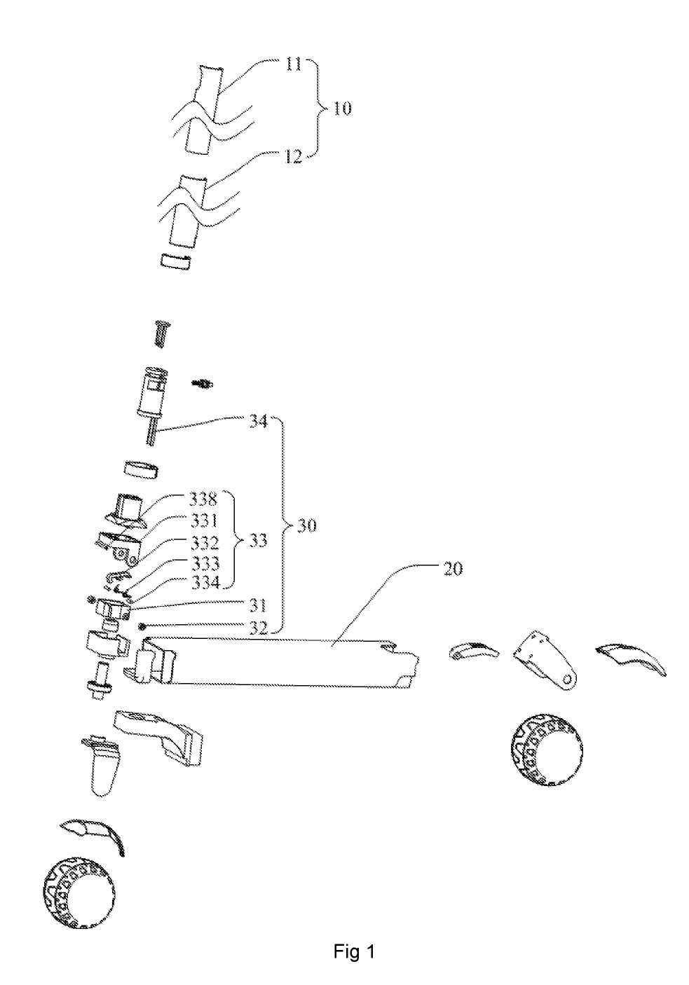

Referring to FIG. 1-3, the scooter of the present invention includes a column 10, a footboard 20, and a folding mechanism 30 which is disposed between the column 10 and the footboard 20, and is for controlling the column 10 of the scooter to fold relative to the footboard 20 of the scooter.

The folding mechanism 30 includes a base 31, a rotating shaft 32, a folding assembly 33 and a triggering assembly 34 for triggering the movement of the folding assembly 33. The base 31 and the folding assembly 33 the base and folding assembly form a hinge-joint by the rotating shaft 32, so that the folding assembly 33 is rotatable about the rotating shaft 32, so as to lock or unlock the base 31 during its rotation, which respectively corresponding to the scooter's riding state or folding state.

The triggering assembly 34 is disposed in the column 10, and the external shape of the folding assembly 33 is fitted with the inner wall of the column 10, so there is no exposed part out of the scooter, the structure is compact, which is safe and reliable, meanwhile, it also improves the scooter's appearance.

In the embodiment of the present invention, the triggering assembly 34 is slidably disposed on the side of the folding assembly 33, and particularly it may be located at the up side, or down side, or left side, or right side of the control portion of the folding assembly 33. Thus, by sliding the triggering assembly 34 towards the folding assembly and press against the control portion of it, making the folding assembly 33 release the base 31 and switch into a pre-folding state. By this time, just rotate the column 10 to make it folded relative to the footboard 20.

Preferably, the triggering assembly 34 is disposed on the bottom end of the inner tube 12 of the column 10, when the inner tube 12 is received in the outer tube 11 of the column 10, the triggering assembly 34 descends along with the inner tube 12 and presses against the control portion of the folding assembly 33, so that the folding assembly 33 releases the base 31.

Thereby, according the present invention, the folding assembly 33 can be folded relative to the base 31 merely by controlling the triggering assembly 34 slide towards the folding assembly 33, so the folding action can be triggered by retracting the inner tube 12 into the outer tube 11. Compared with the prior art, an operation step of applying force downward is reduced, the operation is time-saving and effective, which is a great progress to the prior art.

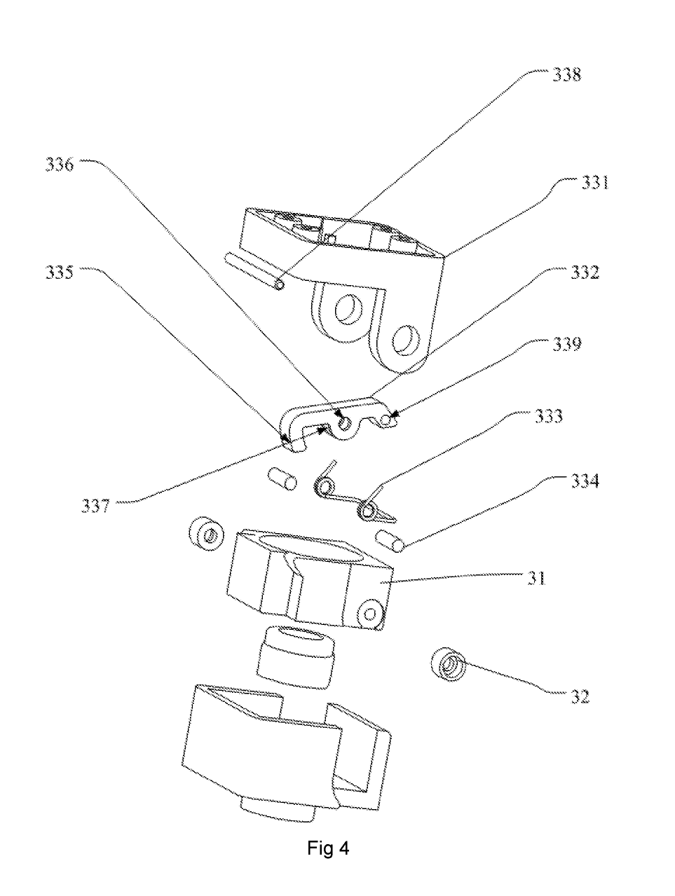

Referring to FIG. 4, in a preferred embodiment of the present invention, the folding assembly 33 includes a mounting seat 331, at least one fastener 332, an elastic member 333 for resetting the fastener 332 to lock the base 31, and a rotation pin 334 for the fastener 332 to rotate. Besides, a locking hook 335 is provided at the front end of the fastener 332, and a wedge-shaped protrusion is provided on the base 31 which is fitted with the locking hook 335. The rotation pin 334 is inserted into the elastic member 333 and a rotating pin hole 336 disposed on the middle portion of the fastener 332, and is rotatably disposed in a mounting slot (not shown in figure) of the mounting seat 331. The triggering assembly 34 is located at the side of the rear portion of the fastener 332 (eg. over the rear portion of the fastener 332).

In specific implementation, the rear portion of the fastener 332 is the control portion of the folding assembly 33. When the rear portion of the fastener 332 is pressed by the triggering assembly 34, the locking hook 335 move upwards to release the wedge-shaped protrusion on the base 31, the folding assembly 33 can be switched into the pre-folding state, and the column 10 is foldable to the footboard 20. When users need to ride, make the column 10 rotate back to the vertical state, at this time, the elastic restoring force of the elastic member 333 drives the locking hook 335 to move downward, the locking hook 335 fitted with and lock the wedge-shaped protrusion.

In order to enhance the stability and reliability of the elastic member 333 when the elastic force restoring, the fastener 332 is provided with a mounting groove 337 for mounting the elastic member 333, the elastic member 333 is disposed in the mounting groove 337, and the rotating pin 334 inserted into the rotating pin hole 336 and the elastic member 333, make the elastic member 333 stable and reliable when it is compressed or restoring the elastic force.

In this embodiment, the number of the fastener 332, the rotating pin 334 and the wedge-shaped protrusion can be one, and the fastener 332 may be designed as block-shaped (namely the fastener 332 has a narrow width), which is mounted on one side of the mounting seat 331, to give space to a connecting pipe (or steering shaft) which may be disposed under the mounting seat 331. The elastic member 333 is a conventional torsion spring (such as a single torsion spring), the detailed configuration of it can be set according to the number and the position of the mounting seat 331.

Surely, the fastener 332 may also be designed as plate-shaped (namely the fastener 332 has a wide width), and a through-out hole may be formed on the fastener 332 for the connecting pipe (or the steering shaft) to pass through, which can also achieve the same effect of the embodiment above. Besides, the plate-shaped fastener 332 has high strength and is not easily deformed, so as to prolong the service life of the folding mechanism 30. In order to improve the stability of the elastic member 333, the elastic member 333 may be a double torsion spring whose elastic force supporting portions are located on the two sides of the fastener 332, so that the both sides of the fastener 332 are force balance.

In a preferred embodiment, the number of the fastener 332, the rotating pin 334 and the wedge-shaped protrusion are all two, the elastic member 333 may also be a double torsion spring. The two fasteners 332 are located on the both sides of the connecting pipe (or steering shaft). During mounting, the rotation pin 334 is inserted into the rotating pin hole 336 of the corresponding fastener 332 from one end of the double torsion spring, the other rotation pin 334 is also inserted into the rotating pin hole 336 of the other fastener 332 from the other end of the double torsion spring, both of the rotating pins are disposed in the mounting slot of the mounting seat 331. In this case, the triggering assembly 34 has two triggering portions, and both of those are located above the rear portion of the fasteners 332, so as to trigger the two fasteners 332 to rotate synchronously. Meanwhile, the fastener 332 has high strength and is not easily deformed and worn, which can also reduce its manufacturing costs.

In a preferred embodiment, the folding assembly 33 further includes a connecting pin 338, the two ends of the connecting pin 338 are respectively inserted into the connecting pin holes 339 at the rear portion of the two fasteners 332. The triggering assembly 34 is slidably disposed above the connecting pin 338. In this case, only one triggering portion is required for the triggering assembly 34, the locking hooks 335 of the two fasteners 332 can be tilted by sliding the triggering assembly 34 downward to press against the connecting pin 338, consequently release the base 31.

Surely, in other embodiments, a connecting piece (not shown in figure) is integrally disposed between the rear portions of the two fasteners 332, the connecting piece is a replacement of said connecting pin 338, so the triggering assembly 34 is slidably disposed above the connecting piece, not only the same effect can be achieved by that, but also simplifies the assembling process of the folding assembly 33, improves the efficiency of assembling.

Based on the folding mechanism 30 described above, the present invention further provides a scooter, as shown in FIG. 1-4, which includes a column 10, a footboard 20 and a folding mechanism 30 rotatably disposed at footboard 20, the folding mechanism 30 is connected to the column 10, and is for controlling the column 10 to fold relative to the footboard 20, make the scooter easy to carry.

Specifically, the column 10 includes an outer tube 11 and an inner tube 12. The inner tube 12 is slidably disposed in the outer tube 11, the triggering assembly 34 of the folding mechanism 30 is disposed in the bottom of the inner tube 12. So, when the inner tube 12 is received in the outer tube 11, the triggering assembly 34 move downward synchronously to trigger the folding action of the folding assembly 33, when the column 10 is in vertical state while the inner tube 12 is pulled out, the folding assembly 33 and the base 31 are engaged and locked up, so as to reset the folding mechanism 30 and complete the locking action of it.

Since the folding mechanism 30 has been described in detail above, it won't be described hereinafter again. In addition, it should be noted that the retractable column 10 is a prior art, while it is not the main point of the present invention, so, that will not be described in detail in the present invention. Moreover, the triggering assembly 34 applied in the present invention shouldn't be limited to any kind of structure, so long as the inner tube 12 retracted in the outer tube 11, the triggering assembly 34 can drive the locking hook 335 of the fastener 332 to be tilted. In addition, when the column 10 is not retractable (eg. the column 10 has only one tube), the triggering assembly 34 may extend through the column 10 until its top end reach out of the handlebar of the scooter, press the top end of the triggering assembly 34 to trigger the folding action.

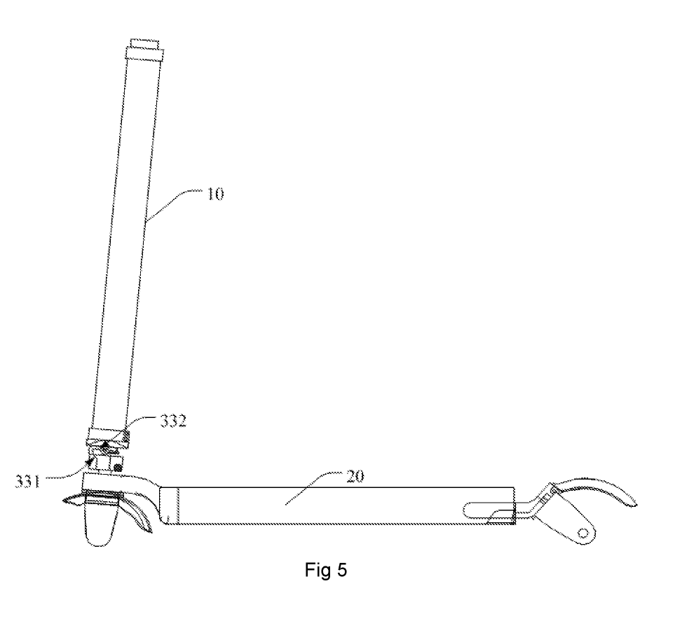

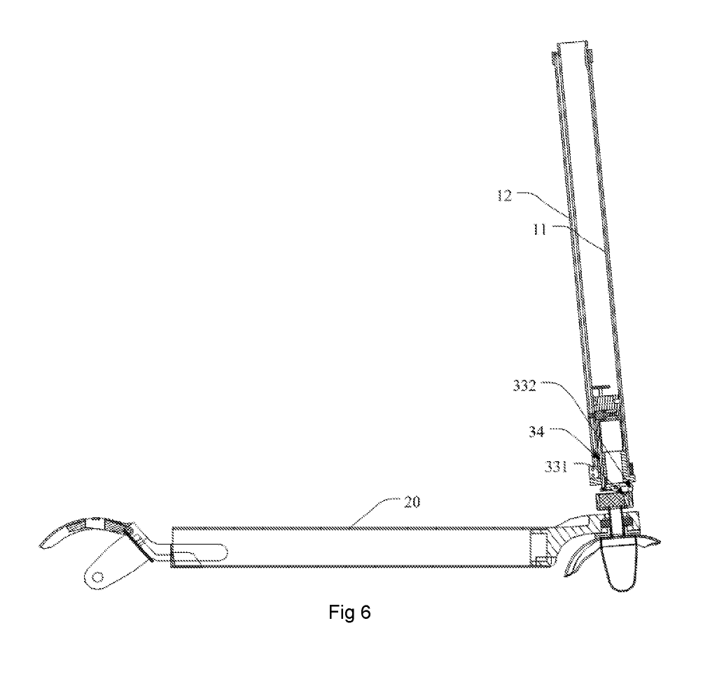

Referring to FIG. 1-6, the present invention also provides a corresponding folding method of the folding mechanism of the scooter, which includes the following steps:

S101, the triggering assembly 34 slides towards the folding assembly 33 to drive the folding assembly 33 to release the base 31;

S102, the folding assembly 33 rotates towards the footboard 20 about the rotating shaft 32, to complete the folding action.

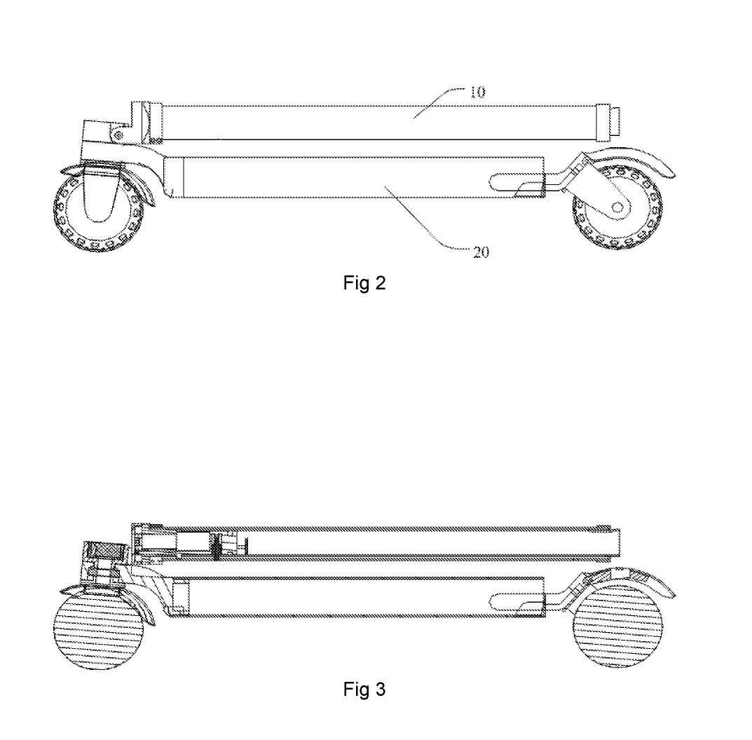

Before the step S101, the folding method further includes: retracting the inner tube 12 into the outer tube 11. When the scooter needs to be folded from the riding state, just retract the inner tube 12 into the outer tube 11, the triggering assembly 34 would move down during the retraction until it touches and press against the connecting pin 338, based on the lever principle, the fastener 332 would rotate around the rotating pin 334, make the locking hook 335 move upwards to release the wedge-shaped protrusion on the base 31, so that the outer tube 11 and the base 31 won't be engaged or locked up, the column 10 can rotate towards the footboard 20 about the rotating shaft 32, to complete the folding action, as shown in FIG. 2 and FIG. 3.

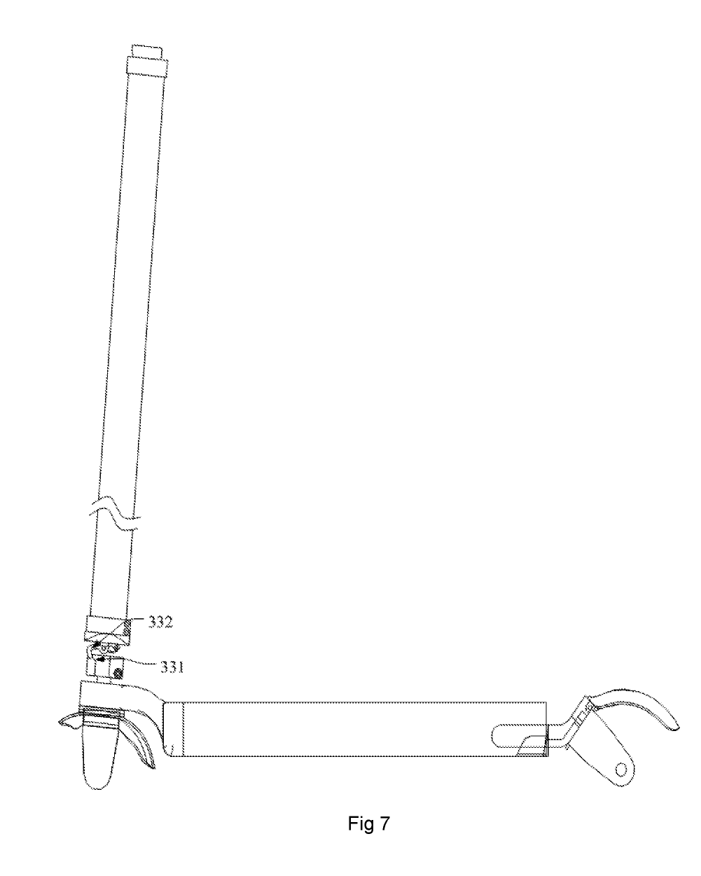

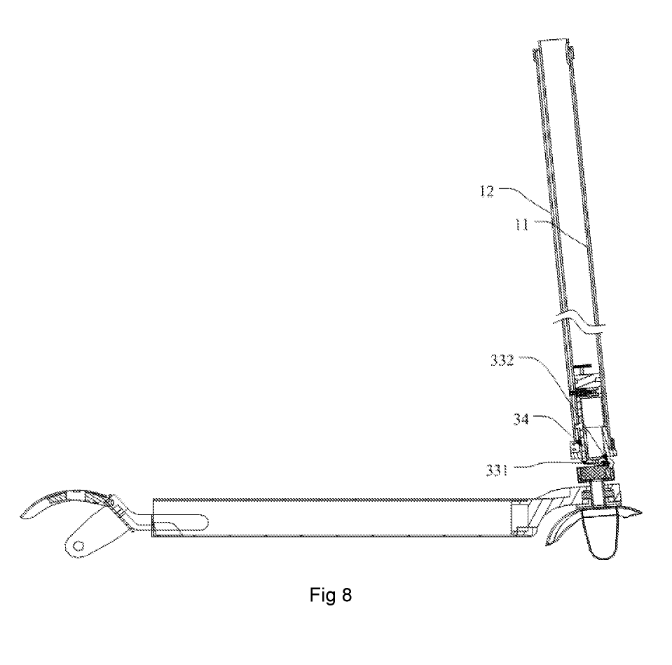

Correspondingly, referring to FIG. 7-8, the present invention also provides a locking method of the folding mechanism of the scooter, which includes the following steps:

S201, sliding the triggering assembly 34 in the direction of keeping away from the folding assembly 33;

S202, the folding assembly 33 engaged with and locked the base 31 under the action of elastic restoring force, to reset the folding mechanism 30 and complete the locking action of it.

Before the step S201, the locking method further includes: rotating the column 10 by 90 degrees in the direction of keeping away from the footboard 20 around the rotating shaft 32, to make the column 10 be perpendicular to the footboard 20. When the column 10 is in the vertical state, pull up the inner tube 12 until the click sound can be heard, means the inner tube 12 has been pulled up to the maximum stroke, at this time, the scooter is in the riding state. At the same time as the inner tube 12 been pulled up, the triggering assembly 34 moves away from the connecting pin 338 along with the inner tube 12, at this moment, the pressure of the fastener 332 is released, the torsion spring reset to rotate the fastener 332 around the rotating pin 334 (in this case, the direction of rotation is opposite to the direction of folding), the rear portion of the fastener 332 moves upwards and the locking hook 335 is engaged with and locked up the wedge-shaped protrusion on the base 31, as the state shown in FIG. 7 and FIG. 8.

Above all, the scooter of the present invention, user just need to control the triggering assembly to slide towards the folding assembly and press against it, can make the folding assembly fold relative to the base, the operation is time-saving and effective. Furthermore, the scooter doesn't have exposed part, the structure is compact, which is safe and reliable. Meanwhile, it also improves the appearance thereof.

At the same time, the folding mechanism of the present invention has the advantages of high strength, difficult to deformation, difficult to wear during the operation, which has long service life and reduced maintenance cost of the scooter. The embodiments of the present disclosure described above are merely exemplary, and are not used to limit the present disclosure. To a person skilled in the art, the disclosed embodiments may be modified or changed in various ways. Any modification, equivalent substitution or improvement made within the spirit and principle of the present disclosure shall fall within the scope of the claims of the present disclosure.

What is claimed is:

1. A folding mechanism of a scooter, to control the column of the scooter to fold relative to the footboard of the scooter, wherein it comprising: base, rotating shaft, folding assembly, and triggering assembly for triggering the movement of the folding assembly; the base and folding assembly form a hinge-joint by the rotating shaft; the triggering assembly is disposed in the column, particularly slidably disposed at the side of the folding assembly.

2. The folding mechanism according to claim 1, wherein the folding assembly comprising: mounting seat, at least one fastener, an elastic member for resetting the fastener to lock the base, and a rotating pin for the fastener to rotate;
the front end of the fastener is provided with a locking hook, the base is provided with a wedge-shaped protrusion which is fitted with the locking hook;
the rotating pin is inserted into the elastic member and a rotating pin hole disposed on the middle portion of the fastener, and is rotatably disposed in a mounting slot of the mounting seat, the triggering assembly is located at the side of the rear portion of the fastener.

3. The folding mechanism according to claim 2, wherein the number of the fastener, the rotating pin and the wedge-shaped protrusion are all two.

4. The folding mechanism according to claim 3, wherein the folding assembly further comprising a connecting pin;
two ends of the connecting pin are respectively inserted into the connecting pin holes of the rear portions of the two fasteners, the triggering assembly is slidably disposed above the connecting pin.

5. The folding mechanism according to claim 3, wherein a connecting piece is integrally formed between the rear portions of the two fasteners, the triggering assembly is slidably disposed above the connecting piece.

6. The folding mechanism according to claim 2, wherein the fastener is provided with a mounting groove for mounting the elastic member.

7. A scooter, comprising column and footboard, wherein further comprising the folding mechanism according to claim 1, the folding mechanism is rotatably disposed on the footboard and further connected to the column.

8. The scooter according to claim 7, wherein the column comprising outer tube and inner tube, the inner tube is slidably disposed in the outer tube, the triggering assembly of the folding mechanism is disposed at the bottom of the inner tube.

9. A method for folding the folding mechanism of a scooter according to claim 1, wherein the method comprising the following steps:
the triggering assembly slides towards the folding assembly to drive the folding assembly to release the base;
the folding assembly rotates towards the footboard about the rotating shaft, to complete the folding action.

10. A method for locking the folding mechanism of a scooter according to claim 1, wherein the method comprising the following steps:
sliding the triggering assembly in the direction of keeping away from the folding assembly;
the folding assembly engaged with and locked the base under the action of elastic restoring force, to reset the folding mechanism and complete the locking action of it.
